(19) United States
(12) Patent Application Publication
(10) Pub. No.: US 2009/0188890 A1
(43) Pub. Date: Jul. 30, 2009

(54) SOLDER VOID REDUCTION ON CIRCUIT BOARDS

(75) Inventor: Atiq KHAN, Cambridge (CA)

Correspondence Address: FASKEN MARTINEAU DUMOULIN LLP, 4200 TORONTO DOMINION BANK TOWER, BOX 20 TORONTO-DOMINION CENTRE, TORONTO, ON, M5K 1N6, CA

(73) Assignee: Research In Motion Limited

(21) Appl. No.: 12/022,917

(22) Filed: Jan. 30, 2008

(51) Int. Cl. B05D 5/12; H01B 13/00; C23F 1/00

(52) U.S. Cl. 216/17; 427/96.2; 118/504; 156/345.3

(57) ABSTRACT

There is disclosed a method, system, and screen for reducing solder voids on circuit boards. In an embodiment, there is provided a method of reducing solder voids on a circuit board, comprising: locating via holes provided at a conductive landing pad; and covering at least some of the via holes with a coating, whereby gases from the covered via holes are prevented from expanding and forming voids. In another embodiment, the method further comprises covering the location of at least some of the via holes in a pattern of strips, whereby more of the via holes may be covered by the coating while reducing areas of the conductive landing pad covered by the coating. In another embodiment, the coating and removal process may be performed at the same time as when all other areas of the circuit board are coated and removed, such that a separate manufacturing step is not required.

### FIELD OF THE INVENTION

The present invention relates generally to a method for reducing voids at solder connection points on circuit boards.

### BACKGROUND

In electronics assembly and manufacturing, a printed circuit board (PCB) is often used to lay down circuits and to provide a base for mounting various types of electronic components. The circuits in the PCBs may comprise electrically conductive pathways traced or etched from conductive material (e.g. copper sheets) onto a non-conductive substrate. Multiple layers of these conductive pathways may be separated by alternating layers of non-conductive substrates in order to form a laminate board that may include many layers of circuits and non-conductive substrates.

In order to electrically connect the circuits in one or more of the conductive layers, “via holes”—namely deliberately formed cavities—may be drilled into the laminate layers of the PCB. Alternatively, the via holes may be formed by evaporating the laminate layers using laser, but this alternative method is thought to be generally less accurate than mechanical drilling. Once the via hole is formed, the inner walls of the holes are plated with copper or another conductive material such that any overlapping conductive pathways located at the point of the via hole are electrically connected between layers. The depth of the drilling may be controlled to connect only some of the layers in the PCB, or the via hole may be drilled straight through the laminate board.

Components are then placed on the PCB at predetermined connection points provided on the outer surfaces of the PCB in order to build various parts of the circuit required for the designed operation of the PCB. Generally speaking, electronic components with leads are attached to the PCB at connection points defined by conductive landing pads or connectors provided on the surface of the PCB to receive the component leads. For electronic components that are to be permanently attached to the PCB, the electrical and mechanical connections between the component leads and the conductive landing pads are typically made using a suitable soldering paste or compound. This solder connection must be strong enough to provide good electrical contact between the electronic component lead and the conductive landing pad, but also provide a strong mechanical connection in order to keep the component in place and provide reliable performance over the long term.

### BRIEF DESCRIPTION OF THE DRAWINGS

In the figures which illustrate exemplary embodiments:

FIG. 1 shows illustrative plan view X-ray images showing large voids that have formed at a solder connection point connecting a component lead to a conductive landing pad;

FIG. 2 shows a schematic block diagram of an illustrative system for reducing solder voids on circuit boards in accordance with an embodiment;

FIGS. 3A to 3C are illustrative plan view images of solder masking of via holes in accordance with various embodiments;

FIG. 4 shows an illustrative plan view of a screen or photo mask in accordance with an embodiment;

FIG. 5 shows illustrative plan view X-ray images showing significantly reduced voids resulting from solder masking of via holes in accordance with various embodiments; and

FIG. 6 shows an illustrative flowchart of a method in accordance with an embodiment.

### DETAILED DESCRIPTION

As noted above, the present invention relates to a method for reducing the size of voids or pockets of air at solder connection points on a circuit board.

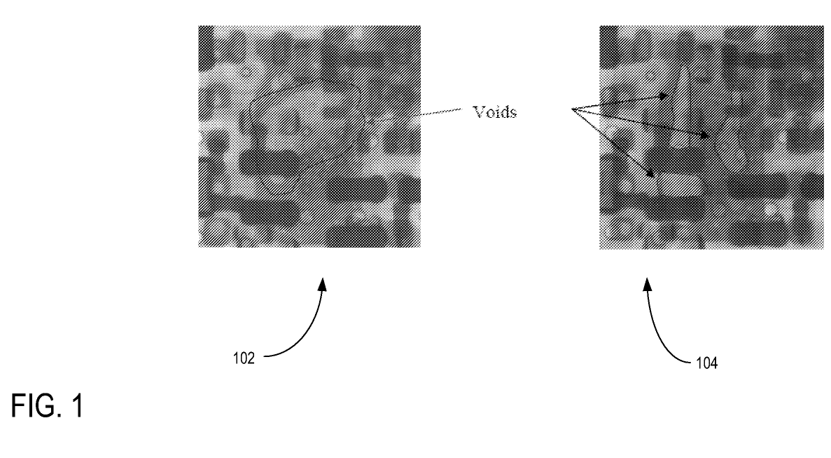

Referring to FIG. 1, during manufacture and assembly of certain PCBs, the inventor noticed several PCB part numbers having a very high degree of void formation at solder connections, representing an average of approximately 22% of the total potential solder connection surface area. Illustrative examples of these voids are shown in FIG. 1, in which X-ray images 102 and 104 of two solder connection points show large pockets of air that have formed between the solder and the conductive landing pad.

The problem of large voids forming at solder joints and within a solder connection is that there is a significant reduction in the solder surface area that is in contact with the conductive landing pad. This reduced connection area may result in an increased probability that the connection may fail prematurely, either electrically or mechanically, over time.

In order to identify the source of the void formation problem, the inventor first conducted a series of tests, including using a different oven reflow profile for liquefying the solder paste and then hardening the melted solder. The inventor also tried different screen aperture designs for providing different volumes and patterns of solder paste on conductive landing pad geometries. However, the inventor found that there was no consistent improvement seen by modifying the reflow profile, or by modifying the screen design to provide a different volume and pattern of solder paste on pad geometry. However, from these series of tests, the inventor finally realized that the problem of large voids forming at the solder joints was as a result of via holes drilled into the conductive landing pads, which contained trapped air. This air expanded significantly during the oven reflow process to form voids or pockets of air within the solder joint, and these voids were then fixed in position during the subsequent solder cooling and hardening process. As a result, the inventor started investigating potential solutions for dealing with the venting of gasses from the via holes.

The inventor considered reducing voids by filling the via holes with copper inserts, but given the potential for hundreds of via holes on a PCB and the very small size of the via holes, it was impractical and costly to implement this solution. Also, an additional assembly step was required to add the copper inserts.

After further experimentation, the inventor discovered that the problem could be solved by modifying a step that was already being used during the PCB manufacturing process. Namely, a non-conductive coating was being applied to the outer surfaces of the PCBs, and a photo masking process was being used to expose and then to remove certain areas of the non-conductive coating, thereby leaving conductive surface areas or pads exposed to allow connection of component leads. The inventor realized that some of the via holes located at the conductive landing pad locations could be left covered with the non-conductive coating instead of being removed during the coating removal process, thereby leaving fewer via holes available to contact the solder. As will be explained in more detail further below, this had the result of significantly reducing the formation and size of voids, thereby increasing the solder connection surface area at the conductive landing pad. It is believed that the non-conductive surface coating applied to the PCB work to either significantly reduce or remove the air trapped within the via holes, or effectively prevents the air trapped within the via holes from escaping during the oven reflow process, or some combination of both.

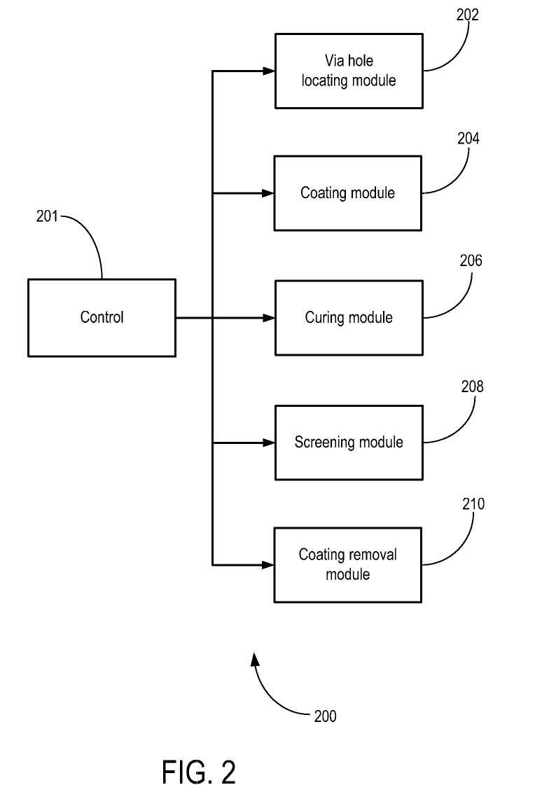

FIG. 2 shows a schematic block diagram of an illustrative system 200 for reducing voids in circuit boards in accordance with an embodiment. As shown, system 200 includes a control 201 for controlling the manufacturing process for the circuit boards or PCBs. System 200 may further include a via hole locating module 202 for locating via holes provided at a conductive landing pad on a PCB. For example, the via hole locating module may include schematic x-y coordinates, relative to a reference point, of the locations and boundaries of the conductive landing pads, and the positions of all of the via holes provided at the conductive landing pads.

System 200 may further include a coating module 204 for applying a coating to the PCB. Coating module may be adapted to apply a non-conductive solder mask coating to the outer surface of the PCB. System 200 may further include a curing module 206 for curing the coating applied by the coating module 204.

Still referring to FIG. 2, system 200 may also include a screening module 208 adapted to position a screen on the PCB, such that portions of the PCB may be covered or exposed as desired. Screening module 208 may be integrated with a submodule to apply a coating removal agent to the exposed portions of the PCB. At coating removal module 210, the coating applied by the coating module 204 at portions of the PCB exposed to the coating removal agent may be removed.

In an alternative embodiment, instead of having the coating applied by the coating module 204 and removed by the coating removal module, the coating may be applied at screening module 208 by using a “negative” screen and by applying the coating to areas of the PCB exposed by the screen. However, it will be appreciated that this may require a separate manufacturing step, with the coating applied to only certain areas of the PCB at conductive landing pads where it is desired to coat the via holes.

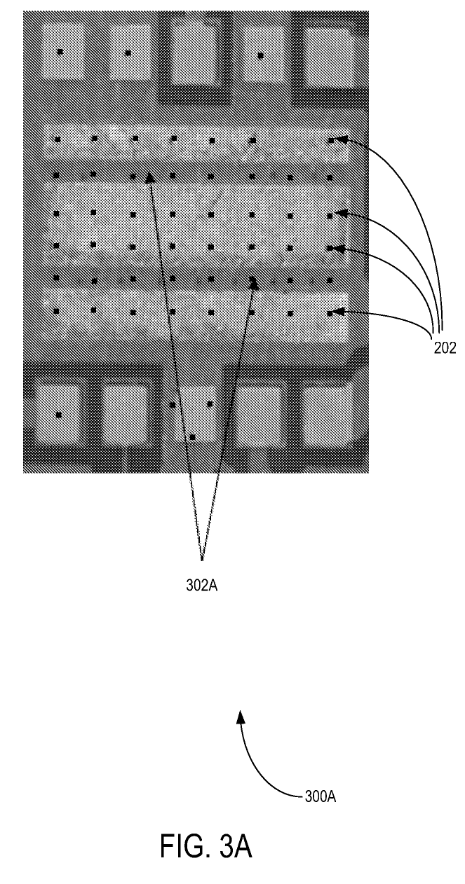

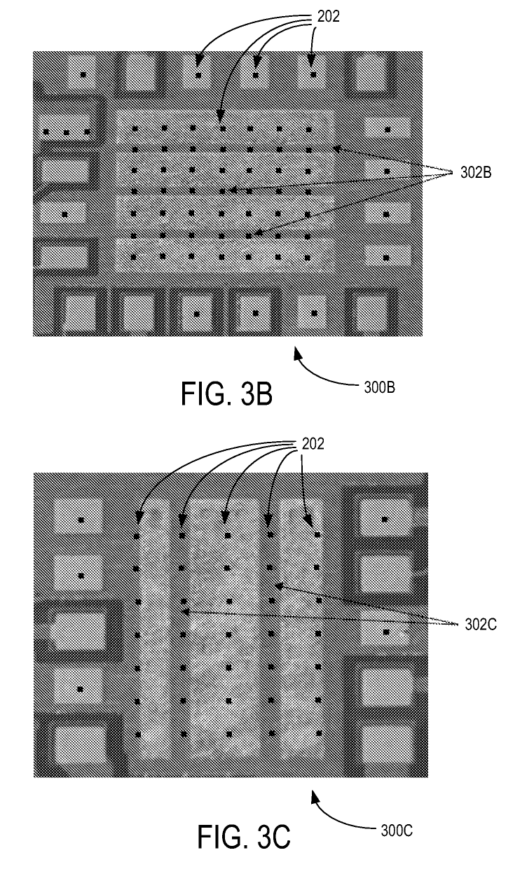

Illustrative plan view images of conductive landing pad geometries modified in accordance with various embodiments are shown in FIGS. 3A to 3C. These are photo images of different pad geometries with dots that have been graphically added to more clearly show the locations of the via holes 202. For example, as shown in FIG. 3A, at least some of the via holes 202 have been left covered by two thin horizontal bands or strips of non-conductive coating at 302A. These horizontal solder mask strips cover some of the via holes lined up underneath these strips, and effectively prevent degassing without impacting on the mechanical connection of the solder to the conductive landing pad. Similarly, FIGS. 3B and 3C show some other conductive landing pad geometries in which solder mask strips have been left on, at 302B and at 302C respectively, to cover via holes.

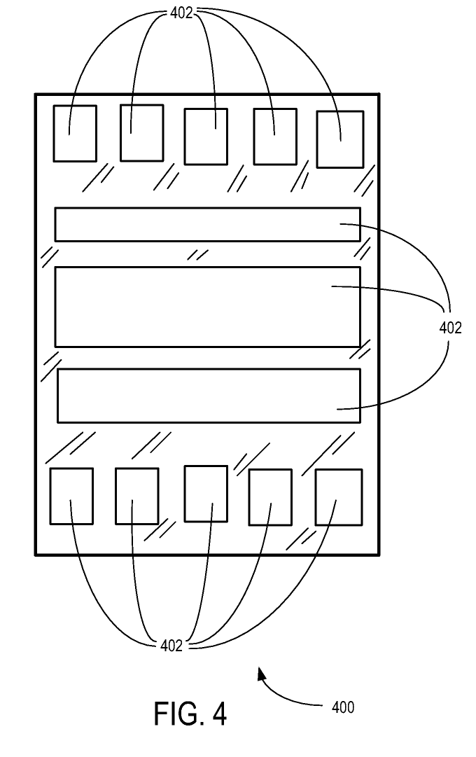

FIG. 4 shows an illustrative plan view of a screen or photo mask 400 having apertures 402 that may be used to leave uncovered areas of the solder mask to be exposed to a solder mask removal agent. This particular example of a screen or photo mask may be used to form the conductive landing pad geometry of FIG. 3A. In another embodiment, the solder mask removal agent may prepare exposed areas of the coating to be removed using a removal process such as chemical etching.

In another embodiment, rather than using a “negative” process, it will be appreciated that a positive process may be used instead to apply a coating over the via holes. Therefore, another screen may be used is a secondary coating application process which leaves at least some of the via holes exposed to the coating, after the conductive landing pad has been previously stripped to expose the conductive plate. However, it will be appreciated that this process would require an additional step in order to apply the coating.

While FIGS. 3A to 3C show the solder masks as being straight line strips, it will be appreciated that the screen or photo mask used to cover areas where the non-conductive coating is left on to cover via holes may be suitably cut to provide various alternative configurations, including solder mask strips that zigzag, or solder mask dots that cover the via holes individually.

While these non-conductive solder mask strips or dots may prevent an electrical connection between the solder and the covered conductive surface area, they do not prevent a mechanical connection, and there is a sufficiently large area provided at the conductive landing pad that remains exposed for an electrical connection. Rather, based on experimental results showing a significant reduction in the size of the voids, it is expected that there would be a net improvement in both the mechanical and electrical performance of the solder joint.

As an illustrative example of improvements seen in experimental results, shown below in Table A are voids measured as a percentage of the overall solder connection surface area (as defined by the outer boundary of the solder connection). As illustrated, over four samples, the overall size of voids averaged approximately 22% of the overall solder surface area, and went as high as 27% in one sample. As will be appreciated, such a large void area may significantly impair the mechanical properties of the solder connection, and also impact reliability of the solder connection over time.

TABLE A
Single Pad Samples

| | Overall Void | Void 1 | Void 2 | Void 3 |
|---|---|---|---|---|
| Sample 1 | 27.21% | 16.23% | 7.63% | 1.28% |
| Sample 2 | 26.02% | 22.67% | 0.82% | 0.54% |
| Sample 3 | 22.31% | 20.72% | 0.80% | 0.22% |
| Sample 4 | 14.00% | 6.00% | 3.49% | 0.90% |
| Average | 22.38% | 16.40% | 3.18% | 0.73% |

In contrast, Table B below shows four samples with substantially similar conductive landing pad geometries as those used in Table A but having at least some of the via holes provided at their conductive landing pads left covered by a solder mask (e.g. as illustrated by example in FIGS. 3A to 3C above). All other variables were kept constant, including the oven reflow profile used to liquefy and then harden the solder. As shown, the overall average size of the voids was significantly reduced to approximately 6.7%.

TABLE B
Split Pad Samples

| | Overall Void | Void 1 | Void 2 | Void 3 |
|---|---|---|---|---|
| Sample 1 | 5.37% | 2.52% | 0.57% | 0.39% |
| Sample 2 | 5.74% | 0.96% | 0.36% | 0.17% |
| Sample 3 | 7.51% | 3.63% | 1.52% | 0.74% |
| Sample 4 | 8.21% | 0.84% | 0.45% | 0.35% |
| Average | 6.71% | 1.99% | 0.72% | 0.41% |

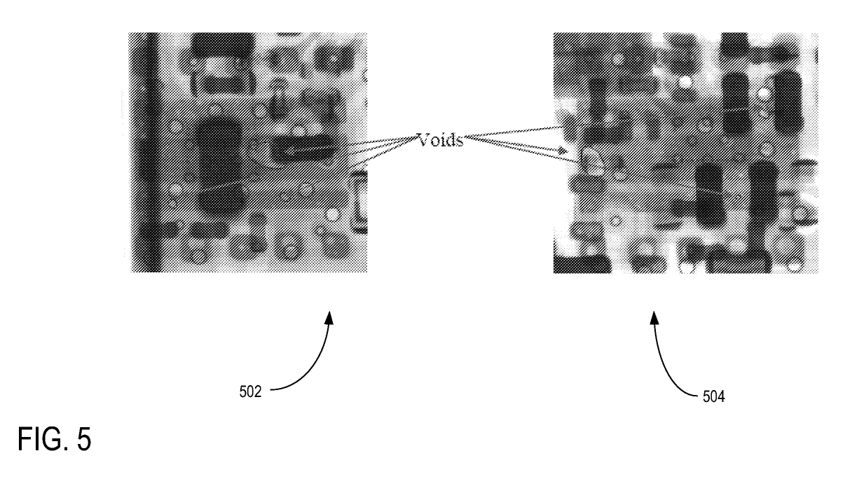

With all other variables kept constant, based on the above results, the inventor came to the conclusion that leaving the solder masks on over some of the via holes resulted in dramatically reduced voiding, thus significantly improving the solder connection. FIG. 5 shows a plan view of an X-ray image of some significantly improved results obtained from conductive landing pad geometries with solder masks.

Importantly, these significant results were obtained simply by modification of a step that was already being performed during the PCB manufacturing process, namely the application of a non-conductive coating onto the outer surface of the PCB, and the subsequent removal of areas of the non-conductive coating to expose underlying conductive landing pads. Therefore, there is no additional processing step required other than the redesign of the screen or photo mask to provide for leaving a solder mask on over some of the via holes located at a conductive landing pad. Therefore, this solution is very cost effective to implement.

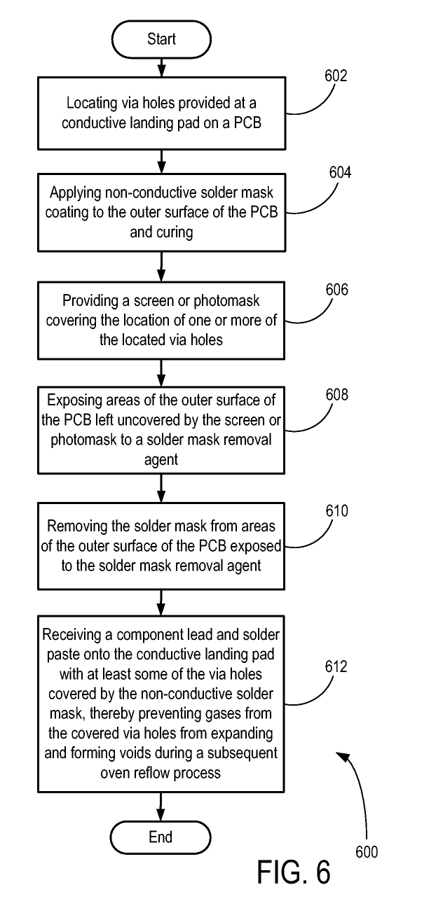

Now referring to FIG. 6, shown is a method in accordance with an embodiment corresponding to the above description. Method 600 begins, and at block 602 method 600 determines the location of via holes provided at a conductive landing pad on a PCB.

Method 600 then proceeds to block 604, where method 600 applies a non-conductive solder mask coating to the outer surface of the PCB, and dries the non-conductive solder mask coating.

Method 600 then proceeds to block 606, where method 600 provides a screen or photo mask covering the location of one or more of the located via holes.

Method 600 then proceeds to block 608, where method 600 exposes areas of the outer surface of the PCB left uncovered by the screen or photo mask to a solder mask removal agent.

Method 600 then proceeds to block 610, where method 600 removes the solder mask from areas of the outer surface of the PCB exposed to the solder mask removal agent.

Next, method 600 proceeds to block 612, where method 600 receives a component lead and solder paste onto the conductive landing pad with at least some of the via holes covered by the non-conductive solder mask, thereby preventing gases from the covered via holes from forming voids during the oven reflow process.

In an embodiment, there is provided a method of reducing solder voids on a circuit board, comprising: locating via holes provided at a conductive landing pad; and covering at least some of the via holes with a coating, whereby gases from the covered via holes are prevented from expanding and forming voids.

In another embodiment, the method further comprises covering the location of at least some of the via holes in a pattern of strips, whereby more of the via holes may be covered by the coating while reducing areas of the conductive landing pad covered by the coating.

In another embodiment, covering at least some of the via holes comprises: positioning a screen over the circuit board, the screen covering the location of at least some of the via holes; exposing areas of the coating at the conductive landing pad left uncovered by the screen to a coating removal agent; and removing the coating from areas of the conductive landing pad exposed to the coating removal agent.

In another embodiment, the screen is a photo mask.

In another embodiment, the method further comprises: positioning a screen over the circuit board, the screen covering the location of the at least some of the via holes; exposing areas of the coating at the conductive landing pad left uncovered by the screen to a chemical etching agent; and removing the coating from areas of the conductive landing pad exposed to the chemical etching agent.

In another embodiment, the method further comprises: positioning a screen over the circuit board, the screen leaving the location of the at least some of the via holes uncovered; and applying the coating to the via holes left uncovered by the screen.

In another embodiment, the method further comprises: covering at least some of the via holes provided at a conductive landing pad at the same time that all other areas of the circuit board are covered; and removing the coating from desired areas of the conductive landing pad at the same time that the coating is removed from all other areas of the circuit board.

In another aspect, there is provided a system for reducing solder voids on a circuit board, the system adapted to locate via holes provided at a conductive landing pad, and cover at least some of the via holes with a coating, whereby gases from the covered via holes are prevented from expanding and forming voids.

In an embodiment, the system is further adapted to cover the location of at least some of the via holes in a pattern of strips, whereby more of the via holes may be covered by the coating while reducing areas of the conductive landing pad covered by the coating.

In another embodiment, the system is further adapted to cover at least some of the via holes by: positioning a screen over the circuit board, the screen covering the location of at least some of the via holes; exposing areas of the coating at the conductive landing pad left uncovered by the screen to a coating removal agent; and removing the coating from areas of the conductive landing pad exposed to the coating removal agent.

In another embodiment, the screen is a photo mask.

In another embodiment, the system is further adapted to cover at least some of the via holes by: positioning a screen over the circuit board, the screen covering the location of the at least some of the via holes; exposing areas of the coating at the conductive landing pad left uncovered by the screen to a chemical etching agent; and removing the coating from areas of the conductive landing pad exposed to the chemical etching agent.

In another embodiment, the system is further adapted to cover at least some of the via holes by: positioning a screen over the circuit board, the screen leaving the location of at least some of the via holes uncovered; and applying the coating to the via holes left uncovered by the screen.

In another aspect, there is provide a screen for use in screening a coating applied a circuit board, the screen adapted to leave a coating covering one or more via holes located at a conductive landing pad, whereby gases from the covered via holes are prevented from expanding and forming voids.

In an embodiment, the screen is adapted to cover the coating applied over one or more via holes located at a conductive landing pad provided on the circuit board, whereby the coating remains over at least some via holes located at the conductive landing pad area.

In another embodiment, the screen is adapted to cover the via holes in a pattern, whereby more of the via holes may be left covered by the coating while reducing areas of the conductive landing pad left covered by the coating.

In another embodiment, the pattern is a strip configured to cover a plurality of via holes across the conductive landing pad.

In another embodiment, the strip is a straight strip configured to cover a plurality of via holes aligned across the conductive landing pad.

In another embodiment, the screen includes positioning guides to accurately position the screen to cover the coating applied over at least some via holes located at the conductive landing pad.

In another embodiment, the screen is adapted to leave uncovered one or more via holes located at a conductive landing pad provided on the circuit board, whereby a coating may be applied to the one or more via holes left uncovered by the screen.

While illustrative embodiments have been described above, it will be appreciated that various changes and modifications may be made. More generally, the scope of the invention is defined by the following claims.

What is claimed is:

1. A method of reducing solder voids on a circuit board, comprising:
locating via holes provided at a conductive landing pad; and
covering at least some of the via holes with a coating, whereby gases from the covered via holes are prevented from expanding and forming voids.

2. The method of claim 1, further comprising covering the location of at least some of the via holes in a pattern of strips, whereby more of the via holes may be covered by the coating while reducing areas of the conductive landing pad covered by the coating.

3. The method of claim 2, wherein covering at least some of the via holes comprises:
positioning a screen over the circuit board, the screen covering the location of at least some of the via holes;
exposing areas of the coating at the conductive landing pad left uncovered by the screen to a coating removal agent; and
removing the coating from areas of the conductive landing pad exposed to the coating removal agent.

4. The method of claim 3, wherein the screen is a photo mask.

5. The method of claim 2, further comprising:
positioning a screen over the circuit board, the screen covering the location of the at least some of the via holes;
exposing areas of the coating at the conductive landing pad left uncovered by the screen to a chemical etching agent; and
removing the coating from areas of the conductive landing pad exposed to the chemical etching agent.

6. The method of claim 1, further comprising:
positioning a screen over the circuit board, the screen leaving the location of the at least some of the via holes uncovered; and
applying the coating to the via holes left uncovered by the screen.

7. The method of claim 1, further comprising:
covering at least some of the via holes provided at a conductive landing pad at the same time that all other areas of the circuit board are covered; and
removing the coating from desired areas of the conductive landing pad at the same time that the coating is removed from all other areas of the circuit board.

8. A system for reducing solder voids on a circuit board, the system adapted to locate via holes provided at a conductive landing pad, and cover at least some of the via holes with a coating, whereby gases from the covered via holes are prevented from expanding and forming voids.

9. The system of claim 8, wherein the system is further adapted to cover the location of at least some of the via holes in a pattern of strips, whereby more of the via holes may be covered by the coating while reducing areas of the conductive landing pad covered by the coating.

10. The system of claim 9, wherein the system is further adapted to cover at least some of the via holes by:
positioning a screen over the circuit board, the screen covering the location of at least some of the via holes;
exposing areas of the coating at the conductive landing pad left uncovered by the screen to a coating removal agent; and
removing the coating from areas of the conductive landing pad exposed to the coating removal agent.

11. The system of claim 10, wherein the screen is a photo mask.

12. The system of claim 9, wherein the system is further adapted to cover at least some of the via holes by:
positioning a screen over the circuit board, the screen covering the location of the at least some of the via holes;
exposing areas of the coating at the conductive landing pad left uncovered by the screen to a chemical etching agent; and
removing the coating from areas of the conductive landing pad exposed to the chemical etching agent.

13. The system of claim 8, wherein the system is further adapted to cover at least some of the via holes by:
positioning a screen over the circuit board, the screen leaving the location of at least some of the via holes uncovered; and
applying the coating to the via holes left uncovered by the screen.

14. A screen for use in screening a coating applied a circuit board, the screen adapted to leave a coating covering one or more via holes located at a conductive landing pad, whereby gases from the covered via holes are prevented from expanding and forming voids.

15. The screen of claim 14, wherein the screen is adapted to cover the coating applied over one or more via holes located at a conductive landing pad provided on the circuit board, whereby the coating remains over at least some via holes located at the conductive landing pad area.

16. The screen of claim 15, wherein the screen is adapted to cover the via holes in a pattern, whereby more of the via holes may be left covered by the coating while reducing areas of the conductive landing pad left covered by the coating.

17. The screen of claim 16, wherein the pattern is a strip configured to cover a plurality of via holes across the conductive landing pad.

18. The screen of claim 16, wherein the strip is a straight strip configured to cover a plurality of via holes aligned across the conductive landing pad.

19. The screen of claim 16, wherein the screen includes positioning guides to accurately position the screen to cover the coating applied over at least some via holes located at the conductive landing pad.

20. The screen of claim 14, wherein the screen is adapted to leave uncovered one or more via holes located at a conductive landing pad provided on the circuit board, whereby a coating may be applied to the one or more via holes left uncovered by the screen.
